(19) United States
(12) Patent Application Publication
(10) Pub. No.: US 2003/0201213 A1
(43) Pub. Date: Oct. 30, 2003

(54) Combined sand and liquor separation for chip transport in pulp processing

(76) Inventors: John F. Bolles, Queensbury, NY (US); Keith P. Vogel, Queensbury, NY (US); Erkki Pulkkinen, Kerimaki (FI)

Correspondence Address: NIXON & VANDERHYE P.C., 8th Floor, 1100 North Glebe Road, Arlington, VA, 22201, US

(21) Appl. No.: 10/132,723

(22) Filed: Apr. 26, 2002

(51) Int. Cl. B04C 3/04; B03B 5/28; B04C 5/107

(52) U.S. Cl. 209/725; 209/730

(57) ABSTRACT

A separation device is disclosed for a cellulose fiber processing system comprising: a particle separation tank having an axis, an upper tangential stream inlet, and a lower particle outlet; an inline drainer column extending at least partially down into the tank and said drainer, wherein the drainer has an inlet within the tank and aligned with the axis of the tank, and the drainer has a clear fluid outlet and an outlet for a mixture of fluid and cellulose fiber.

### FIELD OF THE INVENTION

The present invention relates to a method for pretreatment of fibrous material for use in a cellulose production system. In particular, the invention relates to sand and liquor separation for the containment of fibers being processed in a continuous digester system.

### BACKGROUND OF THE INVENTION

In the art of chemical pulping, natural cellulose material, such as soft wood chips, are treated to produce cellulose pulp from which paper and other products are made. The chips are typically treated in a chemical digester using a kraft cooking processing. The cooking process involves the use of cooking liquor, such as white liquor and black liquor (which is liquor with dissolved organic material (DOM)). The cooking liquors may be extracted from a digester vessel, treated, and recirculated back into the digestion process.

Conventional black liquor treatment processes normally include a sand separator that removes from the black liquor sand and other heavy particulate matter. In addition, an in-line drainer may be used to removes excess liquor and retain useful wood fibers and wood pins in the remaining liquor.

Conventional sand separators remove sand and other particles from a liquid stream, such as kraft cooking liquor being recirculated through a chip transport system in a cellulosic fiber continuous digester plant. A conventional sand separator is shown in U.S. Pat. No. 4,280,902. The sand separator generally includes a tangential inlet to a cylindrical tank. Sand and other heavy particles swirl downward in the tank to a strainer funnel through which the sand and particles pass into a collection basket. The liquid, which is free of particles and sand, is extracted from the sand separator through a center, top outlet port.

Conventional in-line drainers for cellulosic fiber digesting systems are shown in co-pending and commonly-owned U.S. Pat. No. ______ (now application Ser. No. 09/573,390 (NV 10-1309)) entitled “IN-LINE DRAINER ENHANCEMENTS”, and U.S. Pat. No. ______ (now application Ser. No. 09/573,046 (NV-10-1303)) entitled “FEEDING CELLULOSE MATERIAL TO A TREATMENT VESSEL,” both of which are incorporated by reference herein. In-line drainers are also disclosed in U.S. Pat. Nos. 5,536,366 and 5,401,361.

In the conventional use of an in-line drainer, the drainer is positioned in a feed system of a continuous digester, for example, downstream of the outlet of a sand separator (as shown by item 37 in FIG. 1 herein). The liquid passed to the drainer from the sand separator can typically contain at least some wood fibers, chip pins, fine particles or other material. The in-line drainer is typically used to remove excess liquid from the low-pressure liquor circulation associated with the chip feed system. Conventional drainers include cylindrical screen baskets fashioned from steel bars oriented parallel to the direction of flow so that the liquid passes through vertical slots or apertures while retaining wood particles within the circulation. However, the bars and slots may be angled with respect to the flow direction so as to avoid fibers that are parallel to the flow from slipping through bars (which slippage may occur with bars parallel to the flow).

In a conventional in-line drainer of the conventional art, the potential for chips, pins, and fines to align with and pass through the vertical slots of the drainer basket can be minimized by introducing a horizontal velocity component to the liquid flow as it is passes through the drainer. This is typically achieved by introducing a helical baffle, or so-called “flight”, to the inlet of the drainer in order to impart a helical flow to the liquid as it is introduced to the drainer and passes through the drainer basket. Due to this helical flow, any chips, pins, or fines that may be present are oriented in the direction of the helical flow and thus oriented obliquely to the elongation of the slots of the vertical bars. Thus, in the conventional art, the helical flight in the inlet reduces the tendency for chips, pins, and fines to pass through the drainer basket or to be lodged in the slots of the drainer basket and cause pluggage of the drainer.

The conventional wisdom of having a sand separator device and in-line drainer device as separate components has served reasonably well to achieve the desired removal of sand and heavy particulate matters from the black liquor and to drain excess liquid from the black liquor. These separate components have not previously been combined because they perform entirely different functions. The sand separator removes particles, such as sand, from a black liquor stream. In contrast, the in-line drainer strains excess liquor and retains small particles, such as fibers, in a black liquor stream. The removal of sand and other particles from the stream requires different mechanical components than does the removal of excess liquor. It has been conventionally believed that separate devices are needed to remove sand and to extract excess liquor. Typically, a filter device, such as a strainer that is designed to extract excess liquid, will become clogged if subjected to sand or heavy particles. It would have been counterintuitive to form a single device to both filter sand and heavy particles from a black liquor stream and at the same time be applied to remove excess liquid liquor.

### SUMMARY OF THE INVENTION

The present invention combines a sand separator and in-line drainer to form a single device that performs both sand and heavy particle removal as well as extraction of excess liquor. Fine wood fibers flow through the device to the output. But, sand and excess liquor are extracted.

A combined sand separate with internal liquor removal as a single device provides a single compact component to replace two existing devices. By using the outlet flange and internal cylinder of the sand separator to receive a vertical in-line drain strainer, the overall height of the combined component is reduced as compared to the combined height of a sand separator and in-line strainer. The combined device is more compact and takes less volume than would separate sand separator and in-line strainer devices. In addition, a single combined device is believed to have an overall lower acquisition cost than would two separate devices. In particular, it is believed that a combined sand separator in-line drain strainer may be manufactured and sold at a lesser cost than the combined cost of a sand separator and conventional in-line drain strainer.

In one embodiment, the invention is a separation device for a cellulose fiber processing system comprising: a particle separation tank having an axis, an upper tangential stream inlet, and a lower particle outlet; an inline drainer column extending at least partially down into the tank and said drainer, wherein the drainer has an inlet within the tank and aligned with the axis of the tank, and the drainer has a clear fluid outlet and an outlet for a mixture of fluid and cellulose fiber.

In another embodiment, the invention is a method for separating particles and clear fluid from a stream of liquor in a cellulose fiber processing system, wherein said method uses a device having a tank and a drainer column extending down into the tank, said method comprising: injecting the stream of liquor into an upper inlet to the tank; swirling the liquor in the tank such that centrifugal forces move particles towards a perimeter of the tank and away from a centerline of the tank; collecting the particles in a lower portion of the tank; introducing relatively particle free cooking liquor into an inlet to the drainer, where the drainer inlet is within the tank and substantially aligned with the centerline of the tank; in the drainer filtering to separate clear liquor for the relatively particle free liquor which includes cellulose fibers and thereby form condensed relatively free particle free liquor; passing the clear liquor through a clear liquor output of the drainer, and passing the condensed relatively particle free liquor to an outlet.

### BRIEF DESCRIPTION OF THE DRAWINGS

The invention is shown in the accompanying drawings which are:

FIG. 1 is a schematic diagram of a continuous digester system employing a prior art feed system having a separate sand separator and in-line drainer.

FIG. 2 is a schematic diagram of a chip transport system showing a combined sand separator and liquor drainer as a combined device between a chip bin and digester.

### DETAILED DESCRIPTION OF THE INVENTION

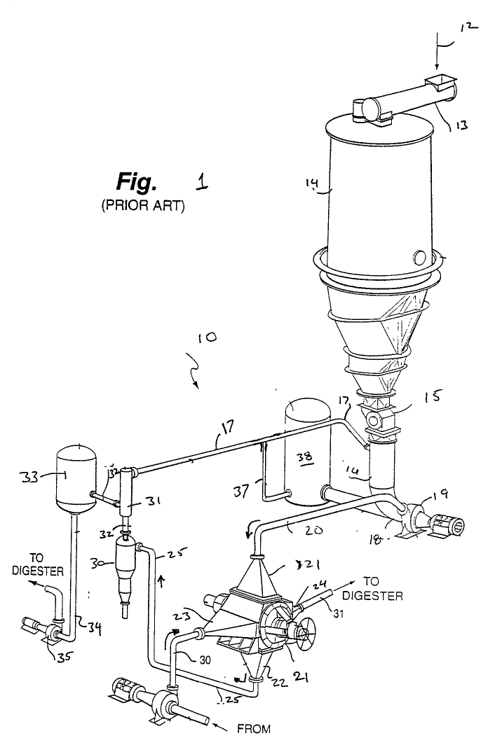

FIG. 1 is an illustration of a typical chip feed system 10 for a continuous cellulose fiber digestion plant.

The term comminuted cellulosic fibrous material may take many forms, including sawdust; grasses, such as straw or kenaf; agricultural waste, such as bagasse; recycled paper; or sawdust, for the sake of simplicity. The term “chips” will be used here when referring to comminuted cellulosic fibrous material, including any and all of the listed materials, and other fibers not listed, that may be processed by the present invention. Also, though a continuous digester in shown in FIG. 1, it is understood that the present invention as also applicable to feeding several continuous digesters or one or more discontinuous or batch digesters.

Chips 12 are introduced to the feed system 10, for example, via a conveyor (not shown) from a chip storage facility, for example, a woodyard, via an isolation and metering device 13. Though various types of vessels are known in the art, chip bin 14 is preferably a DIAMONDBACK® Steaming vessel as marketed by Andritz Inc. of Glens Falls, N.Y. and described in U.S. Pat. Nos. 5,500,083; 5,617,975; 5,628,873; and 4,958,741, or a chisel-type vessel as described in U.S. Pat. No. 6,199,299. The pressure in the bin 14 may be slightly below atmospheric pressure or slightly above atmospheric pressure, that is, the pressure in the bin 14 may vary from about −1 to 2 bar gage (that is, about 0 to 3 bar absolute). Other conventional pressurized steam vessels and chip feed systems could be used as well.

The steamed chip material is discharged from the bottom of the chip bin 14 to a metering device 15, for example, a star-type metering device or Chip Meter as sold by Andritz Inc. of Glens Falls, N.Y., though any type of meeting device may be used. The chips discharged by the metering device 15 are introduced to a vertical conduit or pipe 16, for example, a Chip Tube sold by Andritz Inc. of Glens Falls, N.Y. Cooking chemical and other liquids are typically first introduced to the chips in conduit 16 by means of one or more conduits 17 such that a level of liquid is established in conduit 16 and a slurry of chips and liquid is present in the bottom of conduit 16.

Conduit 16 discharges the slurry of chips and liquid by means of a radiused section 18 to the inlet of slurry pump 19. The slurry pump 19 pressurizes and transfers the slurry in conduit 16 via conduit 18 to the low-pressure inlet 20 of a high-pressure transfer device 21. The high-pressure feeder 21 includes a pocketed rotor mounted in a housing typically having a low-pressure inlet 20, a low-pressure outlet 22, a high-pressure inlet 23 and a high-pressure outlet 24. The low-pressure outlet 22 typically includes a screen plate (not shown) which minimizes the passage of chips out of the low-pressure outlet while allowing the liquid in the slurry to pass out to conduit 25. The chips form a mat on the screen plate, which functions as a much finer strainer, in a manner similar to wedge-wire screens. However, sand and heavy particles (and some chips) do pass through the low-pressure outlet and into the conduit 25.

The liquid discharged from the low-pressure outlet 22 of high-pressure feeding device 21 passes via conduit 25 to a cyclone-type sand separator 30 which isolates undesirable material and debris, such as sand, stones, etc., from the liquid in conduit 25. Liquid having little or no undesirable material or debris is discharged from separator 30 and is passed through in-line drainer liquor-separating device 31 via conduit 32 between the sand separator outlet and the inlet to the in-line drainer. At least some liquid is removed by the in-line drainer 31 via conduit 32 and sent to a level tank 33. Liquid discharged from tank 33 via conduit 34 and pump 35 is supplied to the digester as liquor make-up.

The liquid, with some fibers and chip pins, discharged from the in-line drainer 31 into conduit 17 may be supplemented with cooking chemical, for example, kraft white, green, orange (that is, liquid containing polysulfide additives) or black liquor, introduced via conduit from a liquor surge tank (not shown). The system described above is a Lo-Level® Feed System marketed by Andritz Inc. of Glens Falls, N.Y. Other feed systems could also be used, those systems would involve separate devices for sand separator and in-line drainer.

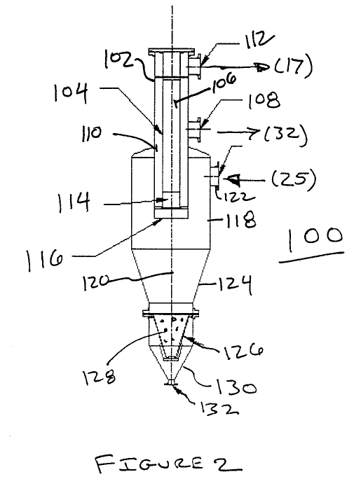

The present invention combines the conventional sand separator 30 and in-line drainer 31 (as shown in FIG. 1 or from other conventional feed systems) into a single device. FIG. 2 shows a sand separator with internal liquid separation device 100. The generally-vertical device includes a first in-line vertical drainer column 102 having an internal cylindrical arrangement of strainer bars 104 and coaxial with the cylindrical outer wall of the drainer column. The strainer bars 104 allow excess liquor to flow through to an interior passage 106 of the drainer and flow upstream to a clear liquor outlet 108. The clear liquor outlet is in fluid communication with the interior passage 106 formed by the cylindrical arrangement of bars. The clear liquid output may be connected to line 32 in FIG. 1.

An outer annular volume 110 of the drainer column 102 is formed between the cylindrical strainer bars and the outer wall of the strainer 102. In this outer volume 110, black liquor, with pulp fines and pin chips, flow upwards through the column to a liquor and slurry output 112. This output may be coupled to line 17 in FIG. 1.

A lower end of the strainer basket includes a spiral device 114 that imparts a swirl to the flow of the stream entering the drainer. The swirl flow prevents fine and pin chips from becoming caught between bars in the drainer. The spiral increases the suspension of the fines and pin chips in the slurry entering the drain column. The spiral is adjacent and downstream of the inlet 116 to the drainer cylinder. The inlet 116 to the drainer cylinder is contained within a cylindrical tank 118 that forms the sand separator portion of the combined device 100. Approximately one-half of the length of the drainer column 102 may be housed within the sand separator tank 118. The drainer 102 may be mounted vertically along the vertical axis 120 of the sand separator tank. The drainer may extend through the top of the tank 118 and down into the tank such that the inlet 116 to the drainer is about halfway down into the depth of the tank and aligned with the tank centerline 120. Due to the swirl in the tank, sand and heavy particles do not flow towards the centerline of the tank. Rather, the centrifugal force imparted by the swirling flow moves sand and other heavy particles to the perimeter of the tank. Thus, the fluid in the tank along the centerline is relatively free of sand and particles.

Appropriate structural devices are used to mount the drain cylinder to the sand separator device. These structural devices may include flanges, braces and other support devices to hold the drainer column 102 vertically in the top of the tank 118.

The tank 118 is a generally-cylindrical vessel having at an upper end a dirty liquor inlet 122 that receives dirty liquor mixed with sand, other heavy particles, wood fibers and pin chips, via line 25 shown in FIG. 1. The dirty liquor inlet is in communication with the low-pressure output 22 of a high-pressure feeder 21 from a downstream portion of the chip transport system.

Dirty liquor enters the top of the sand separator tank 118 and settles within the tank. The dirty liquor enters the tank tangentially, and swirls around the tank. As the stream of dirty liquor swirls in the tank, sand and other large particles sink towards the bottom of the sand separator tank. The bottom of the tank may include a conical lower section 124 that funnels down towards a funnel strainer 126 at the bottom of the tank. The funnel has perforations 128 on its conical outer surface. These perforations are sufficiently large that sand and other large particles flow through them and into a sand basket 130 that forms a lower outer housing to the bottom of the tank and surrounds the funnel. The housing has a sand discharge port 132.

In operation, the dirty liquor inlet 122, which is mounted tangentially to the circular wall of the tank, allows dirty liquor to flow with some velocity into the tank. As the liquor enters the tank, it swirls around the tank. Heavy particles and sand contained within the dirty liquor tend to fall due to the force of gravity towards the bottom of the tank. As the sand and heavy particles swirl in the tank, they are propelled due to centrifugal forces to the outer periphery of the tank. As the sand and heavy particles flow along the outer surface of the tank, they ultimately drop down in the tank to the sand funnel 126. The perforations 128 in the outer circumference of the sand funnel allow the sand and other heavy particles to flow through the perforations and into the lower housing and sand catcher 130. As the sand catcher fills, the sand and other heavy particles may be removed via an outlet 132 to the housing.

In the tank of the sand separator, the liquor in the upper portions of the tank, especially along the centerline axis of the tank, is relatively free of sand and other heavy particles. The inlet 116 to the drainer column is oriented in the sand tank 118 along the centerline 120 of the tank and towards the upper half of the tank. Thus, the inlet to the in-line drain is positioned in the sand tank such as to receive dirty liquor which is relatively free of sand and heavy particles.

By positioning the inlet 116 to the in-line drainer at the center upper portion of the sand tank, the in-line drainer may be housed at least partially within the sand tank. The combined in-line drain and sand separator form a compact unitary device to perform the separate functions of sand removal and excess liquor removal.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A separation device for a cellulose fiber processing system comprising:
a particle separation tank having an axis, an upper tangential stream inlet, and a lower particle outlet;
an inline drainer column extending at least partially down into the tank and said drainer, wherein the drainer has an inlet within the tank and the inlet aligned with the axis of the tank, and the drainer has a clear fluid outlet and an outlet for a mixture of fluid and cellulose fiber.

2. A separation device as in claim 1 wherein the inlet to the drainer is at a level of the tank lower than the stream inlet.

3. A separation device as in claim 1 wherein the drainer includes a screening column having an inlet in fluid communication with the inlet to the drainer and an outlet to the clear fluid outlet, and wherein the screening column extends at least partially down into the tank.

4. A separation device as in claim 1 wherein the drainer is coaxial with the tank.

5. A separation device as in claim 1 wherein approximately one half of a length of the drainer extends down into the tank.

6. A separation device as in claim 1 wherein the tank is substantially cylindrical and the inlet to the tank is along a tangent to the tank.

7. A separation device as in claim 1 wherein the lower particle outlet includes a conical funnel having apertures through which particles flow to a collection container for particles.

8. A method for separating particles and clear fluid from a stream of liquor in a cellulose fiber processing system, wherein said method uses a device having a tank and a drainer column extending down into the tank, said method comprising:
a. injecting the stream of liquor into an upper inlet to the tank;
b. swirling the liquor in the tank such that centrifugal forces move particles towards a perimeter of the tank and away from a centerline of the tank;
c. collecting the particles in a lower portion of the tank;
d. introducing relatively particle free cooking liquor into an inlet to the drainer, where the drainer inlet is within the tank and substantially aligned with the centerline of the tank;
e. in the drainer filtering to separate clear liquor for the relatively particle free liquor which includes cellulose fibers and thereby form condensed relatively free particle free liquor;
f. passing the clear liquor through a clear liquor output of the drainer, and
g. passing the condensed relatively particle free liquor to an outlet.

9. A method as in claim 8 wherein the inlet to the drainer is at a lower portion of the tank than is the upper inlet to the tank.

10. A method as in claim 8 wherein the drainer includes a screening column having an inlet in fluid communication with the inlet to the drainer and an outlet to the clear fluid outlet, and wherein the screening column extends at least partially down into the tank, such that the step of filtering is performed at least partially within the tank.

11. A method as in claim 8 wherein the drainer is coaxial with the tank and the filtering step is performed along a column in the drainer coaxial to the tank.

12. A method as in claim 8 wherein approximately one half of a length of the drainer extends down into the tank.

13. A method as in claim 8 wherein the tank is substantially cylindrical and the swirling liquor in the tank circulates around a circular perimeter of the tank.

14. A method as in claim 8 wherein the collection of particles includes passing the particles through a conical funnel in the tank having apertures through which the particles flow to a collection container for particles.
